(19) United States
(12) Patent Application Publication
(10) Pub. No.: US 2021/0119193 A1
(43) Pub. Date: Apr. 22, 2021

(54) BATTERY PACK STRUCTURES MADE OF EXPANDABLE POLYMER FOAMS

(71) Applicant: FORD GLOBAL TECHNOLOGIES, LLC, Dearborn, MI (US)

(72) Inventors: Mohammadreza EFTEKHARI, Northville, MI (US); Patrick Daniel MAGUIRE, Ann Arbor, MI (US)

(21) Appl. No.: 16/658,488

(22) Filed: Oct. 21, 2019

(51) Int. Cl. H01M 2/10; H01M 10/42; H01M 10/6554; H01M 2/20; H01M 10/625; B60L 50/64

(52) U.S. Cl. CPC H01M 2/1094; H01M 10/4257; H01M 2/1077; H01M 10/6554; H01M 2220/20; H01M 10/625; B60L 50/64; H01M 2010/4271; H01M 2/206

(57) ABSTRACT

This disclosure details exemplary battery pack designs for use in electrified vehicles. An exemplary battery pack may include a battery system and an expandable polymer foam enclosure that substantially encapsulates the battery system. An expandable polymer foam may be introduced into a mold, expand, and then cure around to battery system to form the enclosure.

### TECHNICAL FIELD

This disclosure relates generally to battery packs that include structures made of expandable polymer foams.

### BACKGROUND

The desire to reduce automotive fuel consumption and emissions has been well documented. Therefore, electrified vehicles are being developed that reduce or completely eliminate reliance on internal combustion engines. In general, electrified vehicles differ from conventional motor vehicles because they are selectively driven by battery powered electric machines. Conventional motor vehicles, by contrast, rely exclusively on the internal combustion engine to propel the vehicle.

A high voltage battery pack typically powers the electric machines and other electrical loads of the electrified vehicle. An enclosure assembly of the battery pack houses a plurality of battery cells that store energy for powering these electrical loads. Various other internal components, including but not limited to a battery electric control module (BECM), a bussed electrical center (BEC), wiring, and I/O connectors, must also be housed inside the enclosure assembly. There is an ongoing effort to decrease the amount of joints, fasteners, parts, and assembly time of the battery pack.

### SUMMARY

A battery pack according to an exemplary aspect of the present disclosure includes, among other things, a battery array, an electrical distribution system (EDS), and an expandable polymer foam enclosure that encapsulates each of the battery array and the EDS.

In a further non-limiting embodiment of the foregoing battery pack, the expandable polymer foam enclosure is made of an expandable epoxy, an expandable polyurethane, or an expandable silicone.

In a further non-limiting embodiment of either of the foregoing battery packs, the battery packs contain a plurality of input/output connectors. The wiring connects between the plurality of input/output connectors and the BEC.

In a further non-limiting embodiment of any of the foregoing battery packs, the plurality of input/output connectors are exposed outside of the expandable polymer foam enclosure.

In a further non-limiting embodiment of any of the foregoing battery packs, the battery array is positioned adjacent to a heat exchanger plate.

In a further non-limiting embodiment of any of the foregoing battery packs, a thermal interface material is disposed between the battery array and the heat exchanger plate.

In a further non-limiting embodiment of any of the foregoing battery packs, the heat exchanger plate is encapsulated within the expandable polymer foam.

In a further non-limiting embodiment of any of the foregoing battery packs, a bus bar or wiring is secured relative to a portion of the battery array by a retainer clip.

In a further non-limiting embodiment of any of the foregoing battery packs, the expandable polymer foam enclosure forms a spacer that extends within a gap formed between a first battery cell and a second battery cell of the battery array.

In a further non-limiting embodiment of any of the foregoing battery packs, the battery pack includes a battery electronic control module (BECM) and a bussed electrical center (BEC), and the expandable polymer foam enclosure encapsulates each of the battery array, the EDS, the BECM, and the BEC.

A method for manufacturing a battery pack according to another exemplary aspect of the present disclosure includes, among other things, assembling a plurality of components into a battery system, positioning the battery system in a cavity of a mold assembly, and introducing an expandable polymer foam into the cavity. The expandable polymer foam expands and cures within the cavity to form an enclosure that substantially encapsulates the battery system.

In a further non-limiting embodiment of the foregoing method, assembling the plurality of components includes holding a bus bar or wiring relative to the battery system with a retainer clip.

In a further non-limiting embodiment of either of the foregoing methods, the retainer clip includes a base, a pair of retention legs for holding the bus bar or the wiring, and a pair of positioning legs for maintaining a positioning of the retainer clip relative to the battery system or the mold assembly.

In a further non-limiting embodiment of any of the foregoing methods, introducing the expandable polymer foam includes injecting the expandable polymer foam through a sprue of the mold assembly.

In a further non-limiting embodiment of any of the foregoing methods, introducing the expandable polymer foam includes venting air through a vent opening of the mold assembly.

In a further non-limiting embodiment of any of the foregoing methods, the expandable polymer foam includes an expandable epoxy, an expandable polyurethane, or an expandable silicone.

In a further non-limiting embodiment of any of the foregoing methods, the expandable polymer foams fills in a plurality of gaps between adjacent battery cells of a battery array of the battery system.

In a further non-limiting embodiment of any of the foregoing methods, the enclosure substantially encapsulates each of a battery array, a battery electronic control module (BECM), a bussed electrical center (BEC), and an electrical distribution system (EDS) of the battery system.

In a further non-limiting embodiment of any of the foregoing methods, an input/output connector of the battery system is exposed outside of the enclosure.

In a further non-limiting embodiment of any of the foregoing methods, the mold-assembly is a two-piece mold assembly.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates a powertrain of an electrified vehicle.

FIG. 2 illustrates a battery pack of an electrified vehicle.

FIGS. 3 and 4 illustrate select portions of a battery system of the battery pack of FIG. 2. An enclosure of the battery pack is removed in FIGS. 3 and 4 to illustrate the components of the battery system.

FIG. 5 schematically illustrates an expandable polymer foam enclosure positioned to fill the gaps between adjacent battery cells of a battery system.

FIGS. 6, 7, 8, and 9 schematically illustrate a method of manufacturing a battery pack.

### DETAILED DESCRIPTION

This disclosure details exemplary battery pack designs for use in electrified vehicles. An exemplary battery pack may include a battery system and an expandable polymer foam enclosure that substantially encapsulates the battery system. An expandable polymer foam may be introduced into a mold, expand, and then cure around to battery system to form the enclosure. These and other features are discussed in greater detail in the following paragraphs of this detailed description.

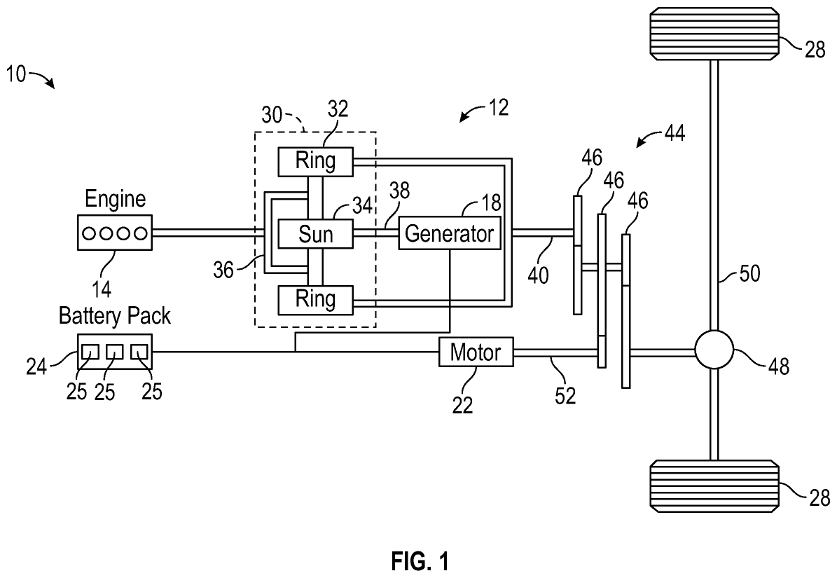

FIG. 1 schematically illustrates a powertrain 10 for an electrified vehicle 12. Although depicted as a hybrid electric vehicle (HEV), it should be understood that the concepts described herein are not limited to HEVs and could extend to other electrified vehicles, including, but not limited to, plug-in hybrid electric vehicles (PHEV's), battery electric vehicles (BEVs), fuel cell vehicles, etc.

In an embodiment, the powertrain 10 is a power-split powertrain system that employs first and second drive systems. The first drive system includes a combination of an engine 14 and a generator 18 (i.e., a first electric machine). The second drive system includes at least a motor 22 (i.e., a second electric machine), the generator 18, and a battery pack 24. In this example, the second drive system is considered an electric drive system of the powertrain 10. The first and second drive systems are each capable of generating torque to drive one or more sets of vehicle drive wheels 28 of the electrified vehicle 12. Although a power-split configuration is depicted in FIG. 1, this disclosure extends to any hybrid or electric vehicle including full hybrids, parallel hybrids, series hybrids, mild hybrids, or micro hybrids.

The engine 14, which may be an internal combustion engine, and the generator 18 may be connected through a power transfer unit 30, such as a planetary gear set. Of course, other types of power transfer units, including other gear sets and transmissions, may be used to connect the engine 14 to the generator 18. In a non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In a non-limiting embodiment, the second power transfer unit 44 is mechanically coupled to an axle 50 through the differential 48 to distribute torque to the vehicle drive wheels 28.

The motor 22 can also be employed to drive the vehicle drive wheels 28 by outputting torque to a shaft 52 that is also connected to the second power transfer unit 44. In a non-limiting embodiment, the motor 22 and the generator 18 cooperate as part of a regenerative braking system in which both the motor 22 and the generator 18 can be employed as motors to output torque. For example, the motor 22 and the generator 18 can each output electrical power to the battery pack 24.

The battery pack 24 is an exemplary electrified vehicle battery. The battery pack 24 may be a high voltage traction battery that includes a plurality of battery arrays 25 (i.e., battery assemblies or groupings of battery cells) capable of outputting electrical power to operate the motor 22, the generator 18, and/or other electrical loads of the electrified vehicle 12 for providing power to propel the wheels 28. Other types of energy storage devices and/or output devices could also be used to electrically power the electrified vehicle 12.

In an embodiment, the electrified vehicle 12 has two basic operating modes. The electrified vehicle 12 may operate in an Electric Vehicle (EV) mode where the motor 22 is used (generally without assistance from the engine 14) for vehicle propulsion, thereby depleting the battery pack 24 state of charge up to its maximum allowable discharging rate under certain driving patterns/cycles. The EV mode is an example of a charge depleting mode of operation for the electrified vehicle 12. During EV mode, the state of charge of the battery pack 24 may increase in some circumstances, for example due to a period of regenerative braking. The engine 14 is generally OFF under a default EV mode but could be operated as necessary based on a vehicle system state or as permitted by the operator.

The electrified vehicle 12 may additionally operate in a Hybrid (HEV) mode in which the engine 14 and the motor 22 are both used for vehicle propulsion. The HEV mode is an example of a charge sustaining mode of operation for the electrified vehicle 12. During the HEV mode, the electrified vehicle 12 may reduce the motor 22 propulsion usage in order to maintain the state of charge of the battery pack 24 at a constant or approximately constant level by increasing the engine 14 propulsion. The electrified vehicle 12 may be operated in other operating modes in addition to the EV and HEV modes within the scope of this disclosure.

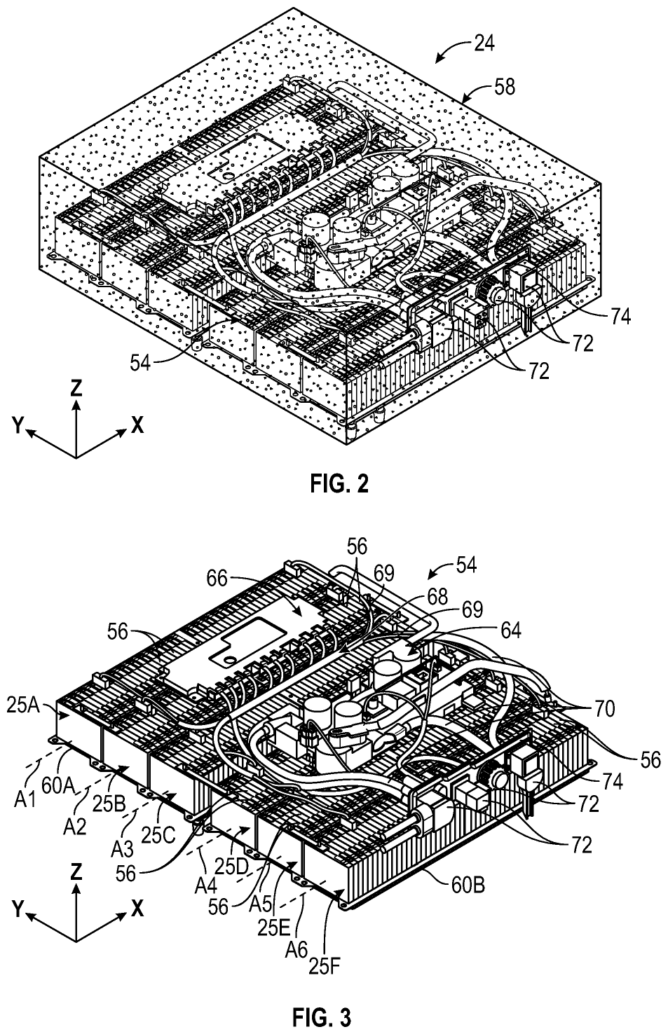

FIG. 2 schematically illustrates a battery pack 24 that can be employed within an electrified vehicle. For example, the battery pack 24 could be incorporated as part of the powertrain 10 of the electrified vehicle 12 of FIG. 1. FIG. 2 is an assembled, perspective view of the battery pack 24.

The battery pack 24 may include a battery system 54 and an expandable polymer foam enclosure 58. The expandable polymer foam enclosure 58 may encapsulate the battery system 54. In an embodiment, the expandable polymer foam enclosure 58 completely encapsulates a majority of the components of the battery system 54, as is further discussed below.

The expandable polymer foam enclosure 58 may be a sealed enclosure and may embody any size, shape, and configuration within the scope of this disclosure. In an embodiment, the expandable polymer foam enclosure 58 is rectangular. However, the expandable polymer foam enclosure 58 could alternatively be triangular, round, irregular, etc.

The expandable polymer foam enclosure 58 may be made of an expandable epoxy, an expandable polyurethane, an expandable silicone, an expandable polypropylene, an expandable polystyrene, or an expandable polyethylene. Generally, each of the forgoing expandable polymer foams are considered relatively structural foamed polymer-based materials. In addition, each of the foregoing expandable polymer foams may be configured to include fire resistive, insulating, dielectric, low viscosity, low molding temperature, and low curing time properties.

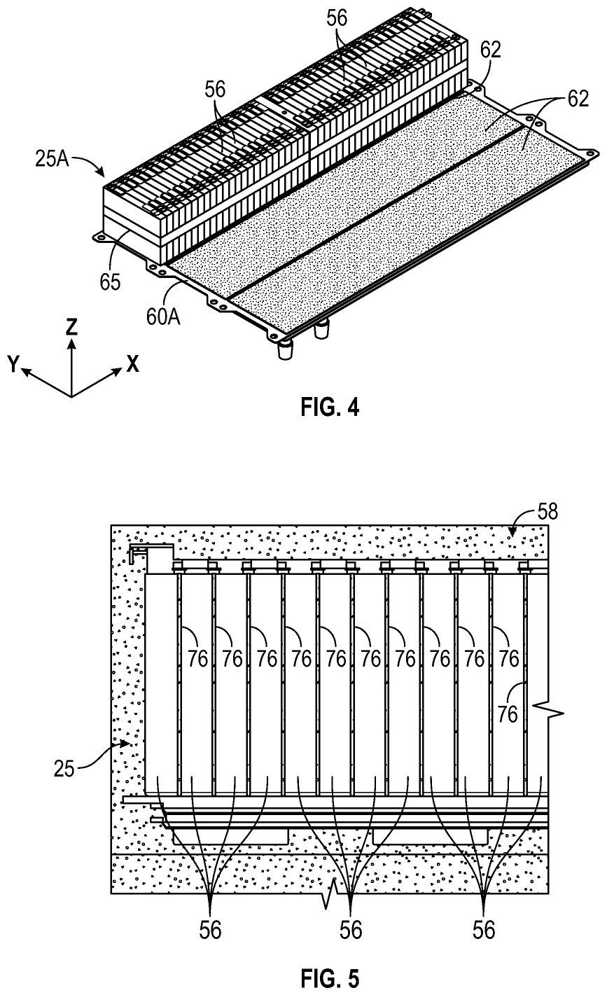

The battery system 54 is shown with the expandable polymer foam enclosure 58 removed in FIG. 3, which will now be described with continued reference to FIGS. 1 and 2. The battery system 54 of the battery pack 24 includes a plurality of battery cells 56 that store energy for powering various electrical loads of the electrified vehicle 12. The battery system 54 could include any number of battery cells within the scope of this disclosure. Therefore, this disclosure is not limited to the exact battery system configuration shown in FIG. 3.

The battery cells 56 may be stacked side-by-side to construct a grouping of battery cells 56, sometimes referred to as a battery array. In an embodiment, the battery cells 56 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery system 54 depicted in FIG. 3 includes a first battery array 25A, a second battery array 25B, a third battery array 25C, a fourth battery array 25D, a fifth battery array 25E, and a sixth battery array 25F. Although the battery system 54 is depicted as including six battery arrays, the battery pack 24 could include a greater or fewer number of battery arrays and still fall within the scope of this disclosure. Unless stated otherwise herein, when used without any alphabetic identifier immediately following the reference numeral, reference numeral “25” may refer to any of the battery arrays 25A-25F.

The battery cells 56 of the first battery array 25A are distributed along a first longitudinal axis A1, the battery cells 56 of the second battery array 25B are distributed along a second longitudinal axis A2, the battery cells 56 of the third battery array 25C are distributed along a third longitudinal axis A3, the battery cells 56 of the fourth battery array 25D are distributed along a fourth longitudinal axis A4, the battery cells 56 of the fifth battery array 25E are distributed along a fifth longitudinal axis A5, and the battery cells 56 of the sixth battery array 25F are distributed along a sixth longitudinal axis A6. In an embodiment, the longitudinal axes A1 through A6 are laterally spaced from and parallel to one another once the battery arrays 25 are encapsulated inside the expandable polymer foam enclosure 58.

In an embodiment, a retention strap 65 may optionally be used to retain the battery cells 56 of each battery array 25 relative to one another in the X-axis and Y-axis directions (see FIG. 4). One or more retention straps 65 may be wrapped around each battery array 25 for retaining the battery cells 56. The retention straps 65 may be a webbed strap made of polyester filament yarn that is woven into a single strap, similar to a composition of a seat belt, for example. Other structural compositions for the retention straps 65 are also contemplated within the scope of this disclosure, including straps of metal or polymer-based straps with continuous fibers such as glass or carbon running across their length.

Each battery array 25 of the battery system 54 may be positioned relative to one or more heat exchanger plates (see features 60A, 60B), sometimes referred to as cold plates or cold plate assemblies, such that the battery cells 56 are either in direct contact with or in close proximity to at least one heat exchanger plate. In an embodiment, the battery arrays 25 are positioned on top of at least one heat exchanger plate. Therefore, the heat exchanger plate at least partially supports the battery cells 56 of each battery array 25 in the Z-axis direction.

In an embodiment, the battery arrays 25A, 25B, 25C share a first heat exchanger plate 60A, and the battery arrays 25D, 25E, and 25F share a second heat exchanger plate 60B. Alternatively, each battery array 25 could be positioned relative to its own heat exchanger plate, or all battery arrays may share a single heat exchanger plate.

A thermal interface material (TIM) 62 (best shown in FIG. 4) may optionally be positioned between the battery arrays 25 and the heat exchanger plates 60A, 60B such that exposed surfaces of the battery cells 56 are in direct contact with the TIM 62. The TIM 62 maintains thermal contact between the battery cells 56 and the heat exchanger plates 60A, 60B, thereby increasing the thermal conductivity between these neighboring components during heat transfer events.

The TIM 62 may be made of any known thermally conductive material. In an embodiment, the TIM 62 includes an epoxy resin. In another embodiment, the TIM 62 includes a silicone based material. Other materials, including thermal greases, may alternatively or additionally make up the TIM 62.

The heat exchanger plates 60A, 60B may be part of a liquid cooling system that is associated with the battery system 54 and is configured for thermally managing the battery cells 56 of each battery array 25. For example, heat may be generated and released by the battery cells 56 during charging operations, discharging operations, extreme ambient conditions, or other conditions. It may be desirable to remove the heat from the battery system 54 to improve capacity, life, and performance of the battery cells 56. The heat exchanger plates 60A, 60B are configured to conduct the heat out of the battery cells 56. In other words, the heat exchanger plates 60A, 60B may operate as heat sinks for removing heat from the heat sources (i.e., the battery cells 56). The heat exchanger plates 60A, 60B could alternatively be employed to heat the battery cells 56, such as during extremely cold ambient conditions.

The battery system 54 may include a plurality of electrical components (see features 64-72) that establish an electrical assembly of the battery system 54. The electrical components may include a bussed electrical center (BEC) 64, a battery electric control module (BECM) 66, an electrical distribution system 68, which may include one or more wiring harnesses 69, wiring 70, a plurality of input/output (I/O) connectors 72, etc. In an embodiment, once encapsulated within the expandable polymer foam enclosure 58, only the I/O connectors 72 (and portions of a connector header bracket 74 that supports the I/O connectors 72), are uncovered by the expandable polymer foam enclosure 58 and are therefore exposed outside of the expandable polymer foam enclosure 58 (see FIG. 2).

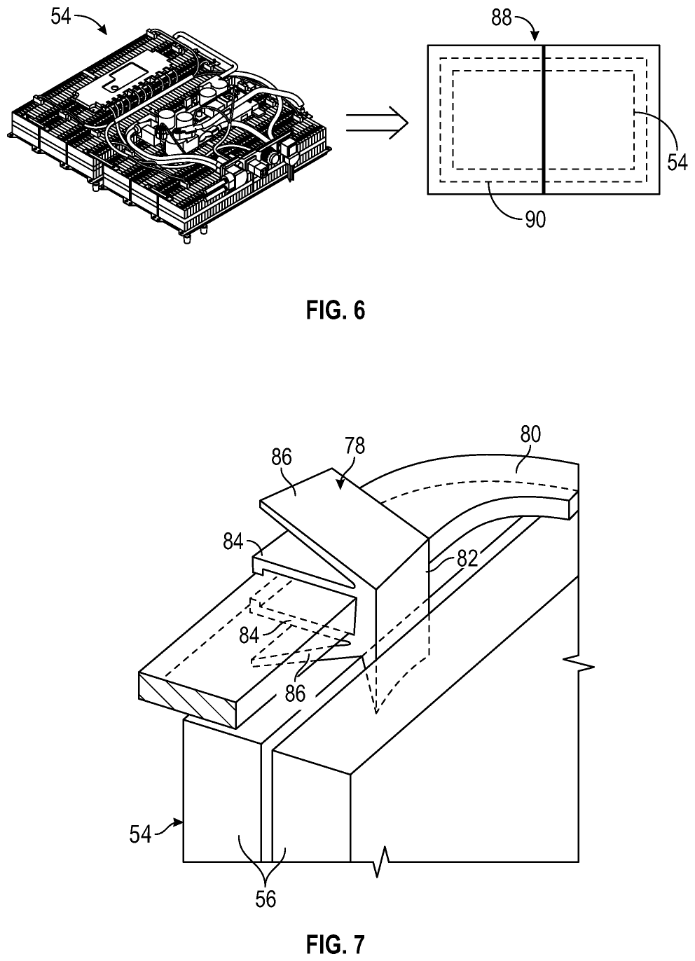

As best shown in FIG. 5, which illustrates the expandable polymer foam enclosure 58 in a cured state, the expandable polymer foam enclosure 58 covers and fills all gaps around and between the battery cells 56 of the battery arrays 25. For example, the expandable polymer foam enclosure 58 may form spacers 76 during the curing process. The spacers 76 are formed between adjacent battery cells 56 of the battery arrays 25 and are thus configured for filling gaps or spaces inside the battery system 54. Alternatively, thin spacers may be pre-installed between the battery cells 56 when the battery arrays 25 are assembled. Therefore, all of the parts that are encapsulated inside the expandable polymer foam enclosure 58 are fitted together with little to no gaps or clearances therebetween. This gapless arrangement between the encapsulated components of the battery system 54 can help retain the components while also improving durability, energy absorption, and load distribution.

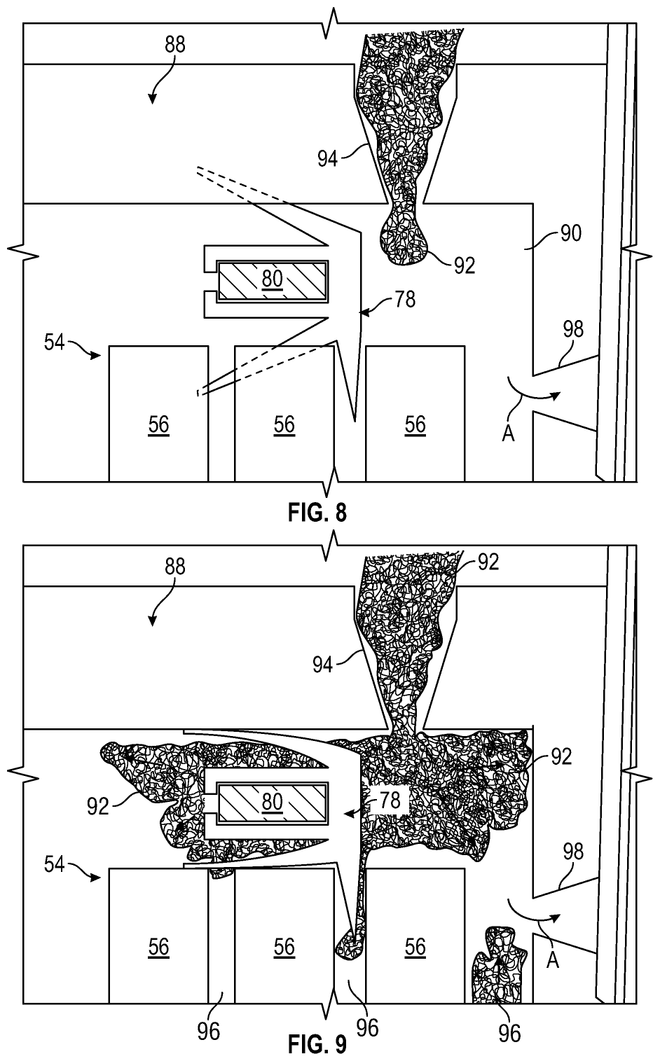

FIGS. 6, 7, 8, and 9, with continued reference to FIGS. 1-5, schematically illustrate an exemplary method for manufacturing the battery pack 24 of FIG. 2. Referring first to FIG. 6, the components of the battery system 54 of the battery pack 24 may be assembled together and staged in their relative positions with respect to one another. Assembly of the battery system 54 may include assembling each battery array 25 by stacking the battery cells 56 together, positioning the battery arrays 25 against the heat exchanger plates 60A, 60B (with or without TIM 62 applied therebetween), securing the BECM 66 in place over the battery arrays 25, securing the BEC 64 in place over the battery arrays 25, attaching the EDS 68 to both the BECM 66 and the battery arrays 25, connecting the wiring 70 to the BEC 64, connecting the I/O connectors 72 to the connector header bracket 74, and connecting the wiring 70 to the I/O connectors 72.

In an embodiment, as shown in FIG. 7, one or more retainer clips 78 may be utilized for positioning and temporarily retaining components 80 of the battery system 54 in place prior to forming the expandable polymer foam enclosure 58 around the battery system 54. The components 80 may be bus bars (for electrically connecting the battery cells 56 and/or adjacent battery arrays 25), wiring (such as the wiring 70 or the wiring harnesses 69), or other electrical components of the battery system 54, or any combination of these components.

Each retainer clip 78 may include a base 82, a pair of retention legs 84, and a pair of positioning legs 86. The retention legs 84 may protrude perpendicularly away from the base 82, and the positioning legs 86 may protrude transversely away from the base 82. In an embodiment, the retention legs 84 are located between the positioning legs 86 and are therefore flanked by the positioning legs 86.

The retention legs 84 may be utilized to hold the components 80, and the positioning legs 86 may be utilized to maintain a positioning of the retainer clip 78 relative to the battery system 54 and a mold assembly 88 that may receive the battery system 54. In an embodiment, the base 82 is insertable between adjacent battery cells 56 of a battery array 25, and the positioning legs 86 are positioned to abut against portions of the battery system 25 and/or portions of the mold assembly 88 to establish the positioning of the retainer clip 78 and the component 80 relative to the battery system 54.

Once assembled, the battery system 54 may be positioned within a cavity 90 of the mold assembly 88 (see FIG. 6). The battery system 54 may be supported by small stand-off features, clip-on supports retained to the heat exchanger plates, forms in the heat exchanger plates, end plates or otherwise, or pin slides in the bottom of the tooling, any of which would be designed to hold the battery system 54 substantially above the bottom of the mold cavity such that the expanded polymer may flow and expand into the space therebetween and substantially or completely enclose the bottom portion of the battery system with an expanded polymer boundary. In an embodiment, the mold assembly 88 is a two-piece mold assembly. However, the specific configuration of the mold assembly 88 is not intended to limit this disclosure.

Next, as shown in FIG. 8, an expandable polymer foam 92 may be introduced into the cavity 90 of the mold assembly 88. In an embodiment, the expandable polymer foam 92 is injected into the cavity 90, at either low or high pressures, through a sprue 94 of the mold assembly 88.

Referring now to FIG. 9, the expandable polymer foam 92 may begin to expand around the battery system 54 once it enters into the cavity 90. During the expansion, the expandable polymer foam 92 may substantially fill in all gaps 96 between adjacent battery cells 56 and may substantially encapsulate a majority of the components of the battery system 54 in their place, including the components 80 that are temporarily held by the retainer clips 78. A vent opening 98 of the mold assembly 88 may permit air A to escape from the cavity 90 during the expansion of the expandable polymer foam 92.

After a relatively short amount of time, the expandable polymer foam 92 will begin to cure, thereby forming the enclosure 58 around the battery system 54. As a result of the expansion and curing of the expandable polymer foam 92, all the gaps between the adjacent battery arrays 25, electrical bussing, EDS 68, BEC 64, BECM 66, and the other internal components of the battery system 54, out to the peripheral boundary of the cavity 90, will be filled and the battery system elements will be substantially covered with a rigid, durable, and tough foam enclosure. The expandable polymer foam enclosure 58 thereby helps retain the battery system components using a minimal amount of fasteners. The use of the expandable polymer foam 92 effectively eliminates the opportunity for relative movement between the components of the battery system 54 once the curing process has completed. Use of the expandable polymer foam enclosure 58 may further facilitate the elimination of various of components that have traditionally been necessary within battery packs, such as bus bar covers over the tops of the battery arrays, battery cell spacers, array frames, array end plates, wiring insulation, and the BEC base housing, BEC bussing, and other supporting components that are part of the BEC. Use of the expandable polymer foam enclosure 58 also replaces the sum of the traditional components which comprise the enclosure (tray, cover, fasteners, seals, access panels, etc.) with one, singular enclosure component: the cured expanded polymer foam enclosure 58.

The exemplary battery packs of this disclosure incorporate expandable polymer foam enclosures that provide numerous benefits over known battery pack assemblies. Among various other benefits, encapsulating battery system components within an expandable polymer foam enclosure enables the reduction of overall parts in assembly, increases energy absorption capabilities and durability loads, improves thermal performance, increases manufacturing throughput, and provides internal and external fire protection.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A battery pack, comprising:
a battery array;
an electrical distribution system (EDS); and
an expandable polymer foam enclosure that encapsulates each of the battery array and the EDS.

2. The battery pack as recited in claim 1, wherein the expandable polymer foam enclosure is made of an expandable epoxy, an expandable polyurethane, or an expandable silicone.

3. The battery pack as recited in claim 1, comprising a plurality of input/output connectors, wherein wiring connects between the plurality of input/output connectors and the BEC.

4. The battery pack as recited in claim 3, wherein the plurality of input/output connectors are exposed outside of the expandable polymer foam enclosure.

5. The battery pack as recited in claim 1, wherein the battery array is positioned adjacent to a heat exchanger plate.

6. The battery pack as recited in claim 5, comprising a thermal interface material disposed between the battery array and the heat exchanger plate.

7. The battery pack as recited in claim 5, wherein the heat exchanger plate is encapsulated within the expandable polymer foam.

8. The battery pack as recited in claim 1, comprising a bus bar or wiring secured relative to a portion of the battery array by a retainer clip.

9. The battery pack as recited in claim 1, wherein the expandable polymer foam enclosure forms a spacer that extends within a gap formed between a first battery cell and a second battery cell of the battery array.

10. The battery pack as recited in claim 1, comprising:
a battery electronic control module (BECM); and
a bussed electrical center (BEC),
wherein the expandable polymer foam enclosure encapsulates each of the battery array, the EDS, the BECM, and the BEC.

11. A method for manufacturing a battery pack, comprising:
assembling a plurality of components into a battery system;
positioning the battery system in a cavity of a mold assembly; and
introducing an expandable polymer foam into the cavity,
wherein the expandable polymer foam expands and cures within the cavity to form an enclosure that substantially encapsulates the battery system.

12. The method as recited in claim 11, wherein assembling the plurality of components includes:
holding a bus bar or wiring relative to the battery system with a retainer clip.

13. The method as recited in claim 12, wherein the retainer clip includes a base, a pair of retention legs for holding the bus bar or the wiring, and a pair of positioning legs for maintaining a positioning of the retainer clip relative to the battery system or the mold assembly.

14. The method as recited in claim 11, wherein introducing the expandable polymer foam includes:
injecting the expandable polymer foam through a sprue of the mold assembly.

15. The method as recited in claim 11, wherein introducing the expandable polymer foam includes:
venting air through a vent opening of the mold assembly.

16. The method as recited in claim 11, wherein the expandable polymer foam includes an expandable epoxy, an expandable polyurethane, or an expandable silicone.

17. The method as recited in claim 11, wherein the expandable polymer foams fills in a plurality of gaps between adjacent battery cells of a battery array of the battery system.

18. The method as recited in claim 11, wherein the enclosure substantially encapsulates each of a battery array, a battery electronic control module (BECM), a bussed electrical center (BEC), and an electrical distribution system (EDS) of the battery system.

19. The method as recited in claim 18, wherein an input/output connector of the battery system is exposed outside of the enclosure.

20. The method as recited in claim 11, wherein the mold-assembly is a two-piece mold assembly.
